(19) United States
(12) Patent Application Publication
(10) Pub. No.: US 2011/0064945 A1
(43) Pub. Date: Mar. 17, 2011

(54) PLASTIC SUBSTRATES AND METHODS OF FORMING THE SAME

(75) Inventors: Gi Heon KIM, Daejeon (KR); Yong Hae Kim, Daejeon (KR)

(73) Assignee: ELECTRONICS AND TELECOMMUNICATIONS RESEARCH INSTITUTE, Daejeon (KR)

(21) Appl. No.: 12/768,247

(22) Filed: Apr. 27, 2010

(30) Foreign Application Priority Data
Sep. 16, 2009 (KR) 10-2009-0087734

(51) Int. Cl. B32B 5/00; B05D 3/02; B05D 3/12; B32B 27/38; B32B 27/30

(52) U.S. Cl. 428/339; 427/385.5; 427/386; 427/240; 428/413; 428/500; 428/522; 977/773

(57) ABSTRACT

Provided are plastic substrates and methods of forming the same. The method includes applying a protective layer composition including reactive monomers on a organic substrate, and polymerizing the reactive monomers to form a protective layer. The reactive monomers used to form the protective layer may be selected from at least one of monomers represented by following Chemical Formulae 1 to 3,

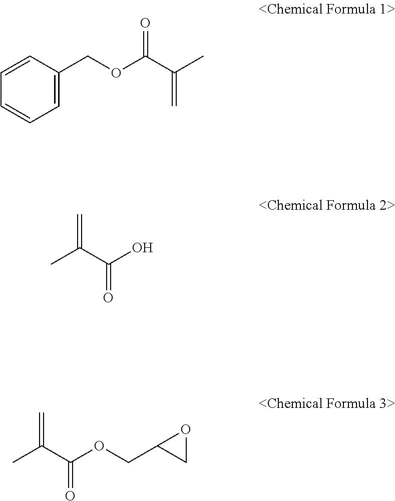

### CROSS-REFERENCE TO RELATED APPLICATIONS

This U.S. non-provisional patent application claims priority under 35 U.S.C. §119 of Korean Patent Application No. 10-2009-0087734, filed on Sep. 16, 2009, the entire contents of which are hereby incorporated by reference.

### BACKGROUND OF THE INVENTION

The present invention disclosed herein relates to flexible substrates and methods of forming the same, and more particularly, to plastic substrates and methods of forming the same.

As electronic devices are diversified, components included therein are also changed variously. For example, a variety of substrates employing organic substances are being developed instead of typical substrates employing inorganic substances.

Recently, with increasing interest in flexible devices, substrates employing organic substances are more preferably used. Unlike substrate employing inorganic substances, substrates employing organic substances are favorably applied to flexible devices due to flexibility. However, it is necessary to complement chemical and mechanical properties of substrates employing organic substances.

### SUMMARY OF THE INVENTION

The present invention provides plastic substrates that improve chemical and mechanical stabilities, and methods of forming the same.

The present invention also provides plastic substrates having minimized substrate defects, and methods of forming the same.

Embodiments of the present invention provide methods of forming a plastic substrate including: applying a protective layer composition including reactive monomers on a organic substrate; and polymerizing the reactive monomers to form a protective layer, wherein the reactive monomers include at least one of monomers represented by following Chemical Formulae 1 to 3,

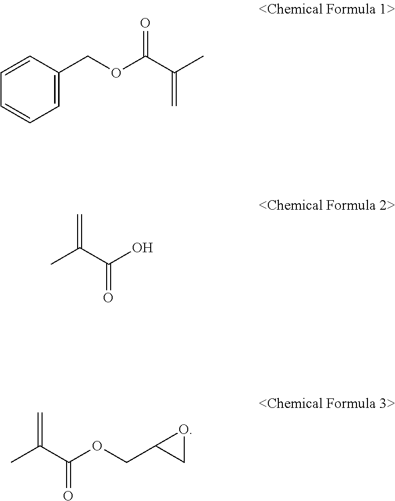

In some embodiments, the polymerizing of the reactive monomers may include adding, into the protective layer composition, at least one of monomers represented by following Chemical Formulae 4 and 5,

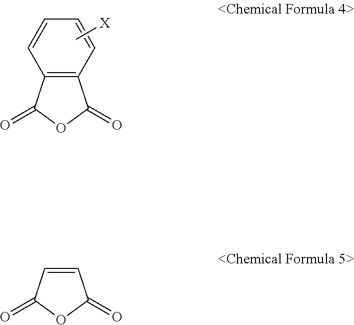

where X is selected from hydrogen, alkyl group having carbon number of 3 or less, and alkenyl group having carbon number of 3 or less.

In other embodiments, the polymerizing of the reactive monomers may include adding at least one of monomers represented by following Chemical Formulae 6 to 8,

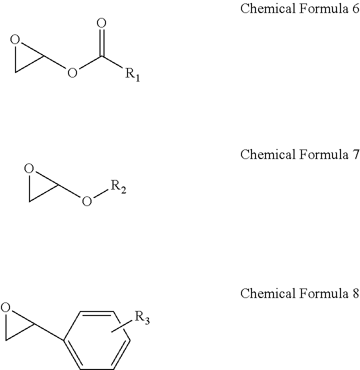

where R1, R2, and R3 are selected from an aromatic or aliphatic group having carbon number of 1 to 30 that includes three or less epoxy groups at a terminal thereof.

In still other embodiments, the protective layer composition may further include inorganic nanoparticles dispersed in the composition.

In even other embodiments, inorganic nanoparticles may form a dispersed system in the protective layer composition.

In yet other embodiments, the inorganic nanoparticle may have a diameter of 100 nm or less.

In further embodiments, an amount of the inorganic nanoparticle in the protective layer composition may range from about 5 wt. % to about 40 wt. %.

In still further embodiments, the inorganic nanoparticle may include at least one of silicon oxide, titanium oxide, silicon nitride, silicon, smectite, kaolinite, dickite, nacrite, halloysite, antigorite, chrysotile, pyrophyllite, montmorillonite, hectorite, tetrasilicicmica, sodiumtaeniolite, muscovite, margarite, talc, vermiculite, phlogophite, xanthophyllite, and chlorite.

In even further embodiments, the applying of the protective layer composition may be performed through a wet process.

In yet further embodiments, the wet process may include at least one of spin-coating process, dip-coating process, and bar-coating process.

In much further embodiments, the protective layer composition may further include a polymerization initiator, wherein the polymerization initiator may include at least one of a photoinitiator, a thermal initiator, a redox initiator, and an acid initiator.

In still much further embodiments, the protective layer composition applied on the substrate further may include an organic solvent into which the reactive monomers are dissolved, wherein the organic solvent is removed during and/or after the polymerizing of the reactive monomers

In other embodiments of the present invention, plastic substrates including: a organic substrate; and a protective layer including an inorganic substance and an organic polymer on the organic substrate, the organic polymer being formed by reactive monomers including at least one of monomers represented by following Chemical Formulae 1 to 3,

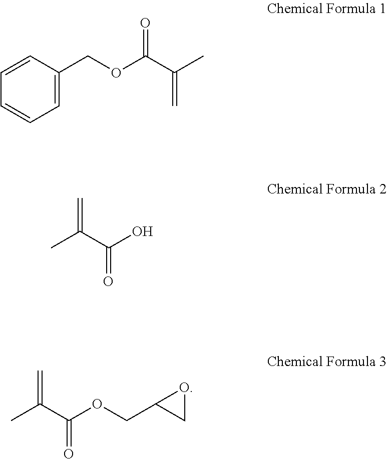

In still other embodiments, the protective layer may further include inorganic nanoparticles dispersed in the protective layer.

In even other embodiments, the organic polymer may further include at least one of monomers represented by following Chemical Formulae 4 and 5,

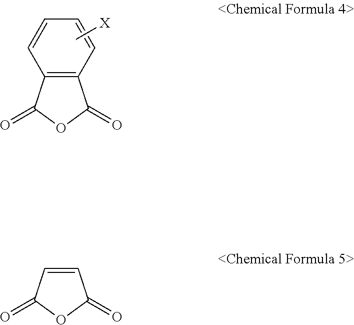

where X is selected from hydrogen, alkyl group having carbon number of 3 or less, and alkenyl group having carbon number of 3 or less.

In yet other embodiments, the organic polymer may further include at least one of monomers represented by following Chemical Formulae 6 to 8,

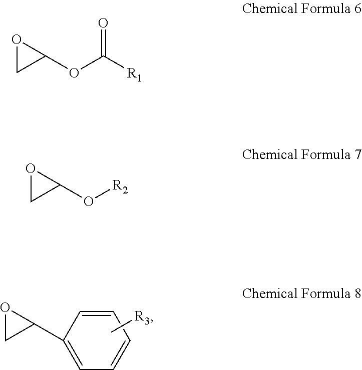

where R1, R2, and R3 are selected from an aromatic or aliphatic group having carbon number of 1 to 30 that includes three or less epoxy groups at a terminal thereof.

In further embodiments, the protective layer may have a thickness ranging from about 0.1 μm to about 3 μm.

In still further embodiments, protective layer may be disposed on a top surface and an undersurface of the organic substrate.

### BRIEF DESCRIPTION OF THE FIGURES

The accompanying drawings are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a cross-sectional view illustrating a plastic substrate and a method of forming the same according to an embodiment of the present invention; and

FIG. 2 is a cross-sectional view illustrating a plastic substrate and a method of forming the same according to another embodiment of the present invention.

### DETAILED DESCRIPTION OF EMBODIMENTS

Hereinafter, plastic substrates and methods of forming the same according to exemplary embodiments of the present invention will be described with reference to the accompanying drawings. Embodiments to be described are provided so that a person with ordinary skill in the art may easily understand the inventive concept, however, the present invention is not limited thereto. Embodiments of the present invention may be modified into other forms within the technical idea and scope of the present invention. As used herein, the term ‘and/or’ includes at least one of elements described in front and rear thereof. It will be understood that when an element is referred to as being ‘on’ another element, it can be directly on the other element, or intervening elements may also be present. Further, it will be understood that although the terms first and second are used herein to describe various elements, these elements should not be limited by these terms. In the drawings, the dimensions, e.g., thicknesses and relative thicknesses, of elements are exaggerated for clarity of illustration.

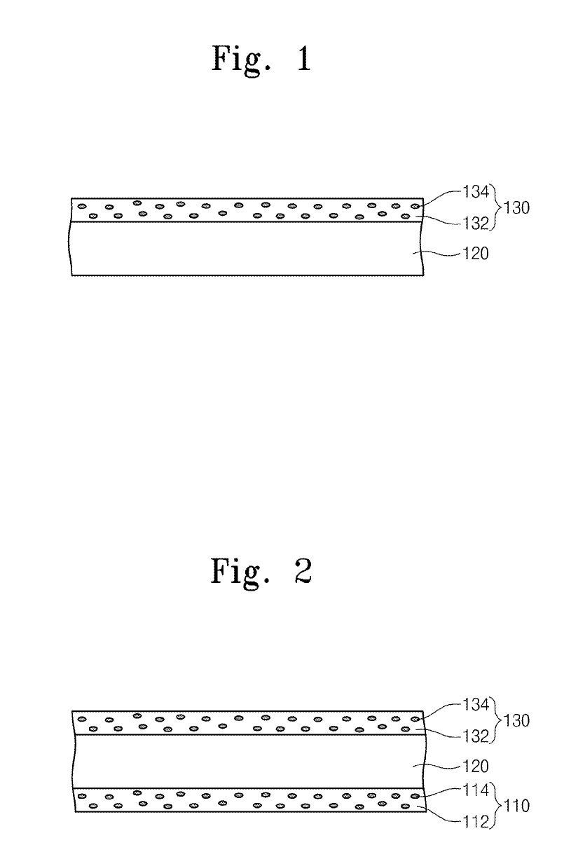

A method of forming a plastic substrate according to an embodiment of the present invention will be described with reference to FIG. 1.

A protective layer composition 132 is prepared. The preparing of the protective layer composition 132 may include preparing acrylate-based reactive monomers. The reactive monomers may be able to cured at low temperature. For example, the preparing of the protective layer composition 132 may include preparing the reactive monomers containing at least one of monomers represented by Chemical Formulae 1 to 3. The reactive monomers selected from monomers represented by Chemical Formulae 1 to 3 may be dissolved in an organic solvent. The organic solvent may be selected from solvents with excellent coating properties. Alternatively, the organic solvent may be omitted according to characteristics of the selected reactive monomers.

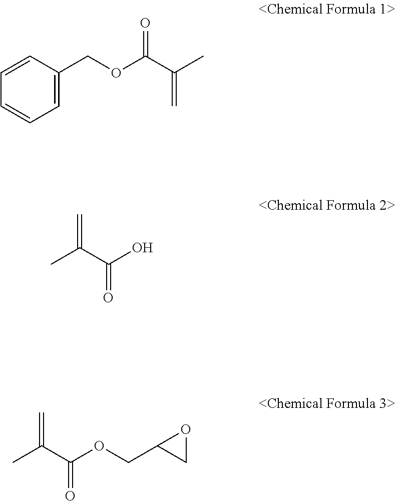

In an embodiment, anhydride-based and/or epoxy-based compounds may be further added so as to increase efficiency of polymerization of the reactive monomers. For example, the organic polymer may further include at least one of monomers represented by following Chemical Formulae 4 and 5, and/or at least one of monomers represented by following Chemical Formulae 6 to 8.

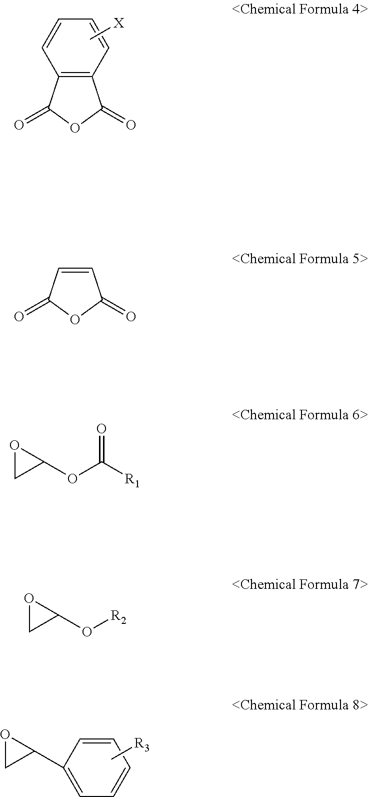

In Chemical Formula 4, X may be selected from hydrogen, alkyl group having carbon number of 3 or less, and alkenyl group having carbon number of 3 or less. In Chemical Formulae 6 to 8, R1, R2, and R3 are selected from an aromatic group or an aliphatic group having carbon number of 1 to 30, and the aromatic group or the aliphatic group may include three or less epoxy groups at a terminal thereof.

In an embodiment, inorganic nanoparticles 134 may be added to the protective layer composition 132.

The inorganic nanoparticle 134 may be at least one selected from materials with high visible light transmission. For example, the inorganic nanoparticle 134 may include at least one selected from silicon oxide, titanium oxide, silicon nitride, silicon, smectite, kaolinite, dickite, nacrite, halloysite, antigorite, chrysotile, pyrophyllite, montmorillonite, hectorite, tetrasilicicmica, sodiumtaeniolite, muscovite, margarite, talc, vermiculite, phlogophite, xanthophyllite, and chlorite.

An average particle size of the inorganic nanoparticle 134 may be sufficiently smaller than the visible light wavelength (about 400 nm to 700 nm). The average particle size of the inorganic nanoparticle 134 may be 100 nm or less. For example, the average particle size of the inorganic nanoparticle 134 may be 50 nm or less. The amount of the inorganic nanoparticle 134 in the protective layer composition 132, that is, a weight ratio of the inorganic nanoparticle 134 to the total weight of the protective layer composition 132 and inorganic nanoparticle 134 may be in the range of about 5 wt. % to about 40 wt. %.

Referring to FIG. 1, the protective layer composition 132 and inorganic nanoparticle 134 are applied on the substrate 120. The protective layer composition 132 and inorganic nanoparticle 134 may be applied on the substrate 120 through a wet process. For example, the protective layer composition 132 may be applied on the substrate 120 by performing at least one process selected from spin-coating, dip-coating, and bar-coating. As the protective layer composition 132 and inorganic nanoparticle 134 are applied on the substrate 120 through the wet process, it is possible to minimize damages of the substrate 120 that may occur during the application of the protective layer composition 132.

The substrate 120 may be a substrate including organic compounds. For example, the substrate may include at least one selected from polyethylene terephthalate (PET), polyethylene naphthalate (PEN), polyetheretherketone (PEEK), polycarbonate (PC), polyimide (PI), polyether sulfone (PES), polyarylite, and cyclic olefin copolymer (COC).

A protective layer 130 may be formed through polymerization of the reactive monomers. The polymerization may be performed by means of a crosslinking reaction of the reactive monomers. A polymerization initiator may be further added so as to polymerize the reactive monomers. The polymerization initiator may include at least one selected from a photoinitiator, a thermal initiator, a redox initiator, and an acid initiator. The photoinitiator may include at least one selected from 1-hydroxy-cyclohexyl-phenyl-ketone (Irgacure 907), 2-methyl-1[4-(methylthio)phenyl]-2-morpholinopropane-1-one (Irgacure 184C), 2-hydroxy-2-methyl-1-phenyl propan-1-one (Darocur 1173), a mixed initiator (Irgacure 500) of Irgacure 184C and benzophenone, a mixed initiator (Irgacure 1000) of Irgacure 184C and Irgacure 1173, 2-hydroxy-1-[4-(2-hydroxyethoxy)phenyl]-2-methyl-1propanone (Irgacure 2959), methylbenzoylformate (Darocure MBF), α,α-dimethoxy-α-phenylacetophenone (Irgacure 651), 2-benzyl-2-(dimethylamino)-1-[4-(4-morpholinyl)phenyl]-1-butanone (Irgacure 369), a mixed initiator (Irgacure 1300) of Irgacure 369 and Irgacure 651, diphenyl(2,4,6-trimethylbenzoyl)-phosphine oxide (Darocur TPO), a mixed initiator (Darocur 4265) of Darocur TPO and Darocur 1173, phosphine oxide, phenyl bis(2,4,6-trimethyl benzoyl) (Irgacure 819), a mixed initiator (Irgacure 2005) of Irgacure 819 and Darocur 1173, a mixed initiator (Irgacure 2010) of Irgacure 819 and Darocur 1173, and a mixed initiator (Irgacure 2020) of Irgacure 819 and Darocur 1173, bis(η5-2,4-cyclopentadien-1-yl)bis[2,6-difluoro-3-(1H-pyrrol-1-yl)phenyl]titanium(Irgacure 784), and a mixed initiator (HSP 188) containing benzophenene. The thermal initiator may include at least one selected from benzoyl peroxide (BP), acetyl peroxide (AP), diauryl peroxide (DP), di-tert-butyl peroxide (t-BTP), cumyl hydroperoxide (CHP), hydrogen peroxide (HP), potassium peroxide (PP), 2,2′-azobisisobutyronitrile (AIBN), and azocompound. The redox initiator may include at least one of silver alkyls and persulfate (K2S208).

In an embodiment, an additive may be further added into the protective layer composition 132. For example, at least one of an ultraviolet stabilizer, an antioxidant, and an antistatic agent may be further added into the protective layer composition 132.

When the protective layer composition 132 applied onto the substrate 120 includes the organic solvent, a process of removing the organic solvent may be further performed. For example, the process of removing the organic solvent may include heating the protective layer composition 132 to a temperature ranging from 120° C. to 150° C.

The protective layer 130 may have a thickness of about 0.1 μm or more. For example, the thickness of the protective layer 130 may be in the range of about 1 μm to about 3 μm.

According to this embodiment of the present invention, the process of forming the protective layer 130 may be repetitively performed. The thickness of the protective layer 130 may be adjusted, thus making it possible to adjust the rigidity and thickness of the plastic substrate including the protective layer 130 according to requirements.

FIG. 2 is a cross-sectional view illustrating a plastic substrate and a method of forming the same according to another embodiment of the present invention. Referring to FIG. 2, protective layers 110 and 130 may be formed on an bottom surface and a top surface of the substrate 120. Although not shown, the protective layers 110 and 130 may be formed to cover entire surfaces of the substrate 120. The protective layers 110 and 130 may include protective layer compositions 112 and 132, and inorganic nanoparticles dispersed in the protective layer compositions 112 and 132.

Forming locations of the protective layers 110 and 130 may be variously selected according to a forming method of the protective layers 110 and 130, and/or a use of the substrate 120. For example, when the protective layers 110 and 130 are formed on the substrate 120 through dip-coating, the protective layers 110 and 130 may be simultaneously formed on both the bottom surface and top surface of the substrate 120. Alternatively, the protective layers 110 and 130 may be formed on both the bottom surface and top surface of the substrate 120 by performing spin-coating process several times.

The plastic substrate according to the embodiment of the present invention will be described referring again to FIG. 1. The description that has been already made shall be omitted herein.

Referring to FIG. 1, the protective layer 130 is disposed on the substrate 120. The protective layer 130 may include a cured protective layer composition 132 and inorganic nanoparticles 134 dispersed in the protective layer composition 132. The inorganic nanoparticles 134 do not chemically bind with the protective layer composition 132, but exists in the protective layer 130 in a state of mixture.

The chemical resistance of the substrate 120 may be enhanced by means of the protective layer 130. Specifically, the protective layer 130 may prevent moisture and oxygen from being permeated into the substrate 120. This makes it possible to enhance the stability and reliability of the substrate 120. Also, the rigidity of the substrate 120 may be improved by means of the protective layer 130. For example, the rigidity is decreased to ⅛ if the thickness of a plastic substrate is decreased to ½, which may deteriorate the stability and reliability of processes seriously. However, in case where the protective layer 130 is disposed on the substrate 120 according to the embodiments of the present invention, the rigidity of the substrate 120 is enhanced, thereby significantly improving the reliability and stability of subsequent processes.

The protective layers 110 and 130 may be formed on both the bottom surface and top surface of the substrate, as illustrated in FIG. 2. Consequently, the chemical resistance and rigidity of the top surface and bottom surface of the substrate 120 may be further enhanced.

According to the embodiments of the present invention, the chemical resistance and rigidity of a substrate can be complemented by means of a protective layer formed on the substrate. Consequently, it is possible to increase the stability and reliability of a device employing the substrate.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a plastic substrate, the method comprising:
applying a protective layer composition including reactive monomers on an organic substrate; and
polymerizing the reactive monomers to form a protective layer,
wherein the reactive monomers include at least one of monomers represented by following Chemical Formulae 1 to 3,

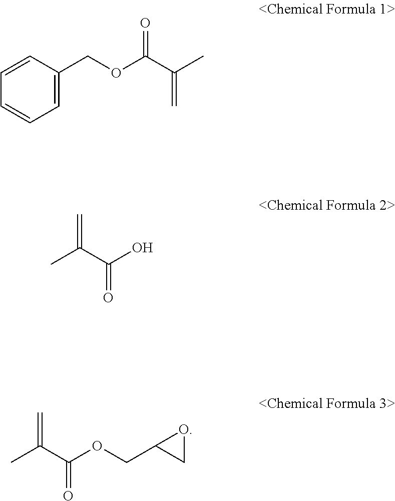

2. The method of claim 1, wherein the polymerizing of the reactive monomers comprises adding, into the protective layer composition, at least one of monomers represented by following Chemical Formulae 4 and 5, 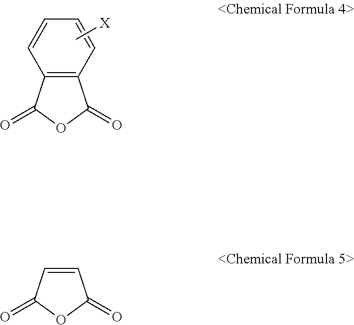
where X is selected from hydrogen, alkyl group having carbon number of 3 or less, and alkenyl group having carbon number of 3 or less.

3. The method of claim 1, wherein the polymerizing of the reactive monomers comprises adding at least one of monomers represented by following Chemical Formulae 6 to 8, 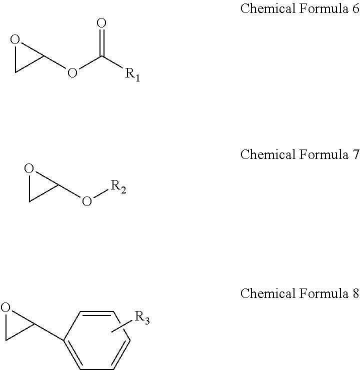
where R1, R2, and R3 are selected from an aromatic or aliphatic group having carbon number of 1 to 30 that includes three or less epoxy groups at a terminal thereof.

4. The method of claim 1, wherein the protective layer composition further comprises inorganic nanoparticles dispersed in the composition.

5. The method of claim 4, wherein the inorganic nanoparticles form a dispersed system in the protective layer composition.

6. The method of claim 4, wherein the inorganic nanoparticle has a diameter of 100 nm or less.

7. The method of claim 4, wherein an amount of the inorganic nanoparticle in the protective layer composition ranges from about 5 wt. % to about 40 wt. %.

8. The method of claim 4, wherein the inorganic nanoparticle comprises at least one of silicon oxide, titanium oxide, silicon nitride, silicon, smectite, kaolinite, dickite, nacrite, halloysite, antigorite, chrysotile, pyrophyllite, montmorillonite, hectorite, tetrasilicicmica, sodiumtaeniolite, muscovite, margarite, talc, vermiculite, phlogophite, xanthophyllite, and chlorite.

9. The method of claim 1, wherein the applying of the protective layer composition is performed through a wet process.

10. The method of claim 9, wherein the wet process comprises at least one of spin-coating process, dip-coating process, and bar-coating process.

11. The method of claim 1, wherein the protective layer composition further comprises a polymerization initiator,
wherein the polymerization initiator comprises at least one of a photoinitiator, a thermal initiator, a redox initiator, and an acid initiator.

12. The method of claim 1, wherein the protective layer composition applied on the substrate further comprises an organic solvent into which the reactive monomers are dissolved,
wherein the organic solvent is removed during and/or after the polymerizing of the reactive monomers.

13. A plastic substrate comprising:
a organic substrate; and
a protective layer comprising an inorganic substance and an organic polymer on the organic substrate, the organic polymer being formed by reactive monomers including at least one of monomers represented by following Chemical Formulae 1 to 3,

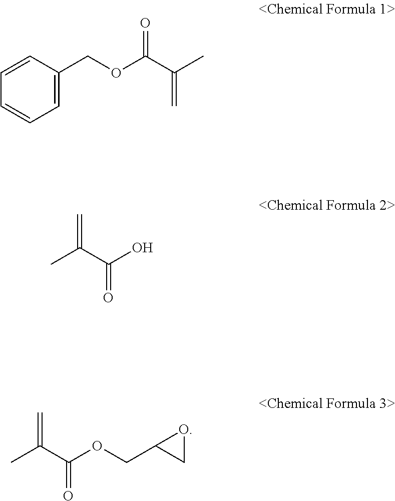

14. The plastic substrate of claim 13, wherein the protective layer further comprises inorganic nanoparticles dispersed in the protective layer.

15. The plastic substrate of claim 13, wherein the organic polymer further comprises at least one of monomers represented by following Chemical Formulae 4 and 5, 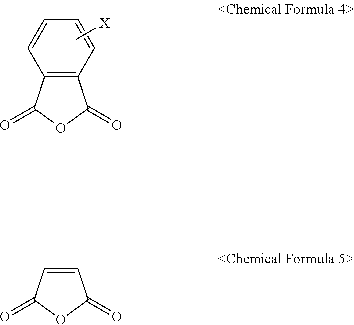
where X is selected from hydrogen, alkyl group having carbon number of 3 or less, and alkenyl group having carbon number of 3 or less.

16. The plastic substrate of claim 13, wherein the organic polymer further comprises at least one of monomers represented by following Chemical Formula 6 to 8, 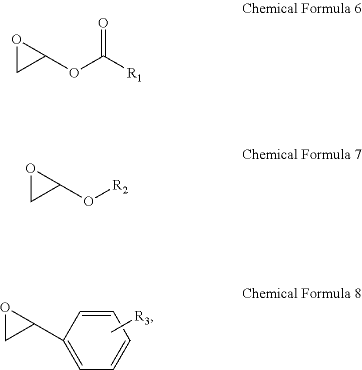
where R1, R2, and R3 are selected from an aromatic or aliphatic group having carbon number of 1 to 30 that includes three or less epoxy groups at a terminal thereof.

17. The plastic substrate of claim 13, wherein the protective layer has a thickness ranging from about 0.1 μm to about 3 μm.

18. The plastic substrate of claim 13, wherein the protective layer is disposed on a top surface and an undersurface of the organic substrate.
